(19) United States
(12) Patent Application Publication
(10) Pub. No.: US 2021/0381777 A1
(43) Pub. Date: Dec. 9, 2021

(54) METHOD OF MANUFACTURING A HEAT DISSIPATION DEVICE

(71) Applicant: ASIA VITAL COMPONENTS CO., LTD., New Taipei City (TW)

(72) Inventors: Kuei-Feng Chiang, New Taipei City (TW); Chih-Yeh Lin, New Taipei City (TW)

(21) Appl. No.: 17/349,857

(22) Filed: Jun. 16, 2021

Related U.S. Application Data
(63) Continuation-in-part of application No. 15/792,997, filed on Oct. 25, 2017, now Pat. No. 11,065,671.

(51) Int. Cl. F28F 3/02; B21D 53/04; F28F 21/08

(52) U.S. Cl. CPC F28F 3/022; B21D 53/04; F28F 21/086; F28F 2255/08; F28F 2245/02; F28F 2275/067; F28F 21/089

(57) ABSTRACT

A method of manufacturing a heat dissipation device is disclosed. The heat dissipation device manufactured with the method includes two titanium metal sheets and a metal mesh. According to the method, the two titanium metal sheets and the metal mesh are subjected to a surface treatment, so that surface of any one of the titanium metal sheets and the metal mesh is modified to form a hydrophilic layer. With these arrangements, the titanium metal material can be freely plastically deformed and possess a capillary force, and the titanium metal sheet can therefore be used in place of the conventional copper sheet to serve as a material for making heat dissipation devices. The heat dissipation devices so produced can have largely reduced weight and largely improved heat dissipation performance.

The present application is a continuation in part of U.S. patent application Ser. No. 15/792,997, filed on Oct. 25, 2017.

### FIELD OF THE INVENTION

The present invention relates to a method of manufacturing a heat dissipation device, and more particularly, to a method of manufacturing a heat dissipation device with pure titanium metal.

### BACKGROUND OF THE INVENTION

The currently available electronic devices all have a largely increased computing speed, and as a result, the electronic elements in the electronic devices tend to produce a high amount of heat while operating. At least one heat dissipation unit, such as a heat pipe, a heat spreader, a vapor chamber or a radiator, is usually adopted by electronic device manufacturers to solve the problem of heat produced by the internal electronic elements. The heat dissipation unit can be directly in contact with or be associated with a heat-producing electronic element to carry the produced heat away from the electronic element. Or, a cooling fan can be further provided and connected to the heat dissipation unit to achieve forced heat dissipation.

Generally, heat dissipation units are made of aluminum, copper or stainless steel because these materials are characterized by high thermal conductivity to enable faster heat dissipation. Among others, copper is the most frequently adopted material for making heat transfer and dissipation devices. While copper has the advantage of high heat transfer speed, it has some disadvantages. For example, copper crystalline grains tend to grow and become coarse when the copper (Cu) material is subjected to a high-temperature reduction process, which would cause largely lowered yield strength of the copper material. In addition, copper has a relatively lower hardness and is easily deformed and could not automatically return to it original shape after the deformation.

In addition, the currently very popular smart handheld devices, such as cell phones, tablet computers and notebook computers, as well as the smart wearing devices and the slim-type electronic devices all require a thinner passive heat dissipation device for heat dissipation. For this purpose, copper foil has been used in place of copper sheet to meet the demands for thinner handheld and wearing electronic devices. However, copper foil is even softer and lacks sufficient structural supporting strength, which renders it not suitable for many specific applications. Further, due to its softness and insufficient supporting strength, copper foil is easily deformed by an external force applied thereto to damage its internal heat transfer structure.

Moreover, heat dissipation units made of aluminum, copper or stainless steel could not be used in some special environments or severe climate conditions, such as a corrosive, highly humid, highly salty, severely cold, high-temperature or vacuum environment or the outer space. Therefore, there are electronic device manufacturers who try to use titanium alloys in place of copper in making heat dissipation units. While titanium alloys have the advantages of high hardness, light weight, and good corrosion, high-temperature and severe cold resistance, they are not easily processed. In other words, while titanium alloys can usually be processed by cutting or some non-conventional machining, they are hardly plastically deformable. That is why titanium alloys still could not be used in place of copper materials at the present time.

### SUMMARY OF THE INVENTION

To overcome the disadvantages of the prior art heat dissipation units, a primary object of the present invention is to provide a method of manufacturing a heat dissipation device. The manufacturing method can effectuate plastic working of commercially pure titanium and the use of commercially pure titanium in place of a copper material in making heat dissipation devices.

To achieve the above and other objects, the method of manufacturing a heat dissipation device according to the present invention includes the following steps:

Prepare a first titanium metal sheet, a second titanium metal sheet and at least one metal mesh, and carry out a pre-cleaning operation for the first and second titanium metal sheets and the metal mesh;

Form a hydrophilic layer on the cleaned surface of the first or the second titanium metal sheet or the metal mesh;

Form a plurality of raised sections on one side of the first titanium metal sheet;

Bond the metal mesh to the surface of one or both of the first and the second titanium metal sheet; and

Close the side of the first titanium metal sheet having the raised sections onto the surface of the second titanium metal sheet having the hydrophilic layer, and carry out subsequent operations, including seam welding, working fluid filling, vacuumizing and sealing.

With the heat dissipation device and the method of manufacturing same according to the present invention, the problem of difficult plastic working of pure titanium, which could not be solved in the past, can be overcome now to enable the provision of a very thin and flexible heat dissipation device structure with good structural strength.

### BRIEF DESCRIPTION OF THE DRAWINGS

The structure and the technical means adopted by the present invention to achieve the above and other objects can be best understood by referring to the following detailed description of the preferred embodiments and the accompanying drawing, wherein

FIG. 1 is a flowchart showing the steps included in a first embodiment of a method of manufacturing a heat dissipation device according to the present invention.

### DETAILED DESCRIPTION OF THE PREFERRED EMBODIMENTS

The present invention will now be described with a preferred embodiment thereof and by referring to the accompanying drawing.

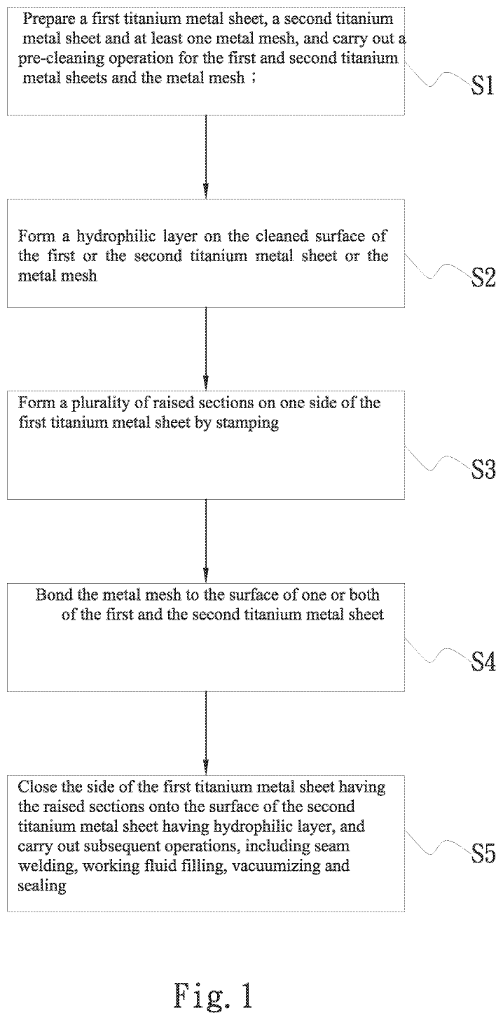

FIG. 1 is a flowchart showing the steps included in a first embodiment of a method of manufacturing a heat dissipation device according to the present invention. As shown, the method includes the following steps:

Step S1: Prepare a first titanium metal sheet, a second titanium metal sheet and at least one metal mesh, and carry out a pre-cleaning operation for the first and second titanium metal sheets and the metal mesh.

More specifically, a pre-cleaning operation is carried out for the first and the second titanium metal sheet and the metal mesh to be further processed. In the pre-cleaning operation, the prepared first and second titanium metal sheets and the metal mesh are wiped with acetone and then washed with de-ionized water in an ultrasonic cleaning machine. Finally, surfaces of the first and second titanium metal sheets and the metal mesh are dried with nitrogen gas. The first and second titanium metal sheets are selected from commercially pure titanium material instead of general titanium alloys. The pure titanium material has the advantage of higher specific strength, i.e. higher tensile strength/density. Copper (Cu) has a density of 8.96 g/cm³ and pure titanium (Ti) has a density of 4.54 g/cm³, which is about one-half of the density of copper. Therefore, compared to copper of the same volume, pure titanium with higher specific strength has higher strength but lower weight.

A layer of oxidized film of TiO₂, TiO₃ or TiO having a thickness of several hundreds of Å (1 Å=10⁻¹⁰ meter), high stability and strong adhesion force will form on the surface of pure titanium at room temperature. The oxidized film formed on the surface of the pure titanium has the ability of self-repairing after a surface damage, which proves titanium is a metal showing a strong tendency of passivation. Therefore, titanium has a corrosion resistance much better than that of copper to facilitate the application of a vapor chamber in various environmental conditions. Titanium shows excellent corrosion resistance in humid environments, seawater, chlorine-containing solutions, hypochlorite, nitric acid, chromic acid and general oxidizing acidic environments.

Step S2: Form a hydrophilic layer on the cleaned surface of the first or the second titanium metal sheet or the metal mesh.

More specifically, the cleaned first and second titanium metal sheets and the metal mesh are positioned in an atmosphere furnace or an oven (not shown). In the case of using an atmosphere furnace, argon gas is supplied into the atmosphere furnace. The atmosphere furnace is then heated to 400° C.˜700° C. for 30˜90 minutes. The main purpose of this step 2 is to form a hydrophilic layer on the surface of the first or the second titanium metal sheet or the surface of the metal mesh through a reduction-oxidation reaction.

Step S3: Form a plurality of raised sections on the first titanium metal sheet by stamping.

More specifically, a plurality of raised sections is formed on one side of the first titanium metal sheet. The raised sections can be formed by etching, stamping or machining. In the case of stamping, the raised sections can be formed by recessing or embossing the surface of the first titanium metal sheet. In the case of machining, a large number of processing manners are available for use. For example, a partial material of the first titanium metal sheet can be removed from the surface of the first titanium metal sheet by cutting, so as to form the raised sections.

Step S4: Bond the metal mesh to the surface of one or both of the first and the second titanium metal sheet.

More specifically, the metal mesh is set on and bonded by diffusion bonding to one or both surfaces of the first and the second titanium metal sheet that are to be correspondingly closed to each other. The first and the second titanium metal sheet are used as heat dissipating sheets of a pure titanium vapor chamber (Ti-VC), and the metal mesh is bonded to the first and/or the second titanium metal sheet at a diffusion bonding temperature of 650° C.˜850° C. The diffusion bonding must be conducted in a process atmosphere of positive-pressure highly pure argon gas (Ar) or in a high vacuum environment of 10⁻⁴˜10⁻⁶ torr at a process pressure of 1 kg˜5 kg for a process time of 30˜90 minutes. Pure titanium is a metal with very active chemical properties and has a phase transformation temperature of 883° C. That is, pure titanium is in a β-phase at a temperature higher than 883° C. and in an α-phase at a temperature lower than 883° C. Pure titanium in the β-phase has a body-centered cubic (BCC) crystalline structure, and pure titanium in the α-phase has a hexagonal close packed (HCP) crystalline structure.

Pure titanium in a high-temperature environment can react with many elements and compounds and undergo a material phase change. For example, titanium starts absorbing hydrogen in the air at 250° C.; starts absorbing oxygen in the air at 500° C.; and starts absorbing nitrogen in the air at 600° C. The ability of titanium to absorb gases is increased with the rising of temperature. Hydrogen (H), oxygen (O), carbon (C) and Nitrogen (N) can react with titanium to form interstitial slid solutions to cause changes or even defects in the mechanical properties of titanium material and form related compounds, such as TiO₂, TiC, TiN and TiH₂, which would have an adverse influence on the material's properties, such as rendering the material to be hard but brittle. Therefore, process temperature and process atmosphere (i.e. process environment control) are very important in related thermal processes when manufacturing a titanium heat spreader.

For a conventional copper vapor chamber (Cu-VC), a metal mesh can be bonded thereto at a diffusion bonding temperature of 750° C.˜950° C. in a process atmosphere of 15% H₂+85% N₂ at a process pressure of 1 kg˜5 kg for a process time of 40˜60 minutes, and no phase change behavior will occur during the high-temperature process. However, copper crystalline grains tend to grow and become coarse when being heated, which would cause largely worsened mechanical properties of the copper material.

Step S5: Close the side of the first titanium metal sheet having the raised sections onto the surface of the second titanium metal sheet having the hydrophilic layer formed thereon, and carry out subsequent operations, including seam welding, working fluid filling, vacuumizing and sealing.

More specifically, after completion of the above steps S1 to S4, the processed first and the second titanium metal sheet are subjected to the operations of seam welding, working fluid filling, vacuumizing and sealing. First, the surfaces of the first and the second titanium metal sheet having the raised sections and the metal mesh are correspondingly closed to each other. Then, seams between the first and the second titanium metal sheet are sealed by means of laser beam welding technique. Finally, the operations of working fluid filling, vacuumizing and sealing are sequentially performed.

In the seam welding process using laser beam welding technique, a solid-state thin-disk Yb:YAG laser material is pumped to produce a laser beam having a wavelength of 1030 nm and a laser power of 100-500 W, depending on a thickness of the material. Further, a protective gas, such as helium or argon, must be supplied into the working environment with a helium leak rate smaller than 1.0×10⁻⁸ mbar-L/sec. Or, the laser beam welding should be performed in a vacuum environment of 10⁻² torr.

Laser beam welding has the advantages of concentrated heat energy source that allows for welding in a narrow area without affecting nearby materials; short working time that won't easily change the mechanical properties of the whole workpiece; ultra-clean welding that does not require any solder; and allowing for easy realization of efficient automated production.

In summary, according to the present invention, commercially pure titanium material is utilized as a substrate material to replace the conventional copper material for manufacturing a heat dissipation device, such as a vapor chamber. The present invention also provides a process for working pure titanium. With the present invention, it is possible to replace copper with pure titanium in the manufacturing of heat dissipation devices so as to overcome some disadvantages of copper. Pure titanium not only can replace copper, aluminum and stainless steel to serve as the material for manufacturing heat dissipation units but also has the advantages of light weight, high structural strength and high corrosion resistance, and is therefore very suitable for making a load-bearing base or a load-bearing bezel of a handheld device or a mobile device. In this case, the load-bearing structure and the heat dissipation device of the handheld or mobile device can be integrally manufactured to meet the present demands for low-profile or slim-type mobile devices or handheld devices and to achieve the effects of bearing load and dissipating heat at the same time.

In the above embodiment, the metal mesh can be made of a material selected from the group consisting of titanium, stainless steel, copper, aluminum, and any other metal material. In other operable embodiment, it is also possible to use a plurality of metal meshes of different materials, such as one titanium mesh and one stainless steel mesh. Alternatively, the plurality of metal meshes can be made of the same material. And, the metal meshes are superposed and located between the first and the second titanium metal sheet.

Pure titanium material in the form of a thin sheet is a shape-memory metal. That is, when the pure titanium material is bent and deformed by an external force applied thereto, the deformed titanium material will return to its pre-deformed shape when the external force is removed. Therefore, thin-sheet pure titanium material can also be directly used with smart watches or be used to manufacture watchbands to provide the smart watches with heat-dissipating and supporting effects at the same time.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of manufacturing a heat dissipation device, comprising the following steps:
preparing a first titanium metal sheet, a second titanium metal sheet and at least one metal mesh, and carrying out a pre-cleaning operation for the first and second titanium metal sheets and the metal mesh;
forming a hydrophilic layer on the cleaned surface of the first or the second titanium metal sheet or the metal mesh;
forming a plurality of raised sections on one side of the first titanium metal sheet;
bonding the metal mesh to the surface of one or both of the first and the second titanium metal sheet; and
closing the side of the first titanium metal sheet having the raised sections onto the surface of the second titanium metal sheet having the hydrophilic layer, and carrying out subsequent operations, including seam welding, working fluid filling, vacuumizing and sealing.

2. The method of manufacturing a heat dissipation device as claimed in claim 1, wherein, in the pre-cleaning operation, the prepared first and second titanium metal sheets are wiped with acetone and then washed with de-ionized water in an ultrasonic cleaning machine; and, finally, surfaces of the first and second titanium metal sheets are dried with nitrogen gas.

3. The method of manufacturing a heat dissipation device as claimed in claim 1, wherein, in the step of forming a hydrophilic layer on the cleaned surface of the first or the second titanium metal sheet or the metal mesh, the first and the second titanium metal sheet and the metal mesh are positioned in an atmosphere furnace or an oven and heated to form the hydrophilic layer through a reduction-oxidation reaction on the surface.

4. The method of manufacturing a heat dissipation device as claimed in claim 1, wherein the metal mesh is bonded to the surface of the first and the second titanium metal sheet by means of diffusion bonding.

5. The method of manufacturing a heat dissipation device as claimed in claim 3, wherein the metal mesh is bonded to the first and the second titanium metal sheet at a diffusion bonding temperature of 650° C.˜850° C. for a process time of 30˜90 minutes.

6. The method of manufacturing a heat dissipation device as claimed in claim 1, wherein, in the step of closing the first and second titanium metal sheets to each other and welding seams between them, the seam welding operation is performed by means of laser beam welding technique using a laser beam having a wavelength of 1030 nm and a laser power of 100-500 W; and the seam welding operation can be performed in a working environment having a protective gas supplied thereinto or in a vacuum environment of 10⁻² torr; and the protective gas can be helium or argon with a helium leak rate smaller than 1.0×10⁻⁸ mbar-L/sec.

7. The method of manufacturing a heat dissipation device as claimed in claim 1, wherein the metal mesh is made of a material selected from the group consisting of titanium and stainless steel.

8. The method of manufacturing a heat dissipation device as claimed in claim 1, wherein two pieces of metal meshes are provided, one of which is a titanium mesh and the other one is a stainless steel mesh; and the titanium mesh and the stainless steel mesh being superposed and located between the first and the second titanium metal sheet.

9. The method of manufacturing a heat dissipation device as claimed in claim 1, wherein two pieces of metal meshes are provided, and the two metal meshes being made of the same metal material.

10. The method of manufacturing a heat dissipation device as claimed in claim 3, wherein, in the step of forming a hydrophilic layer on the cleaned surface of the first or the second titanium metal sheet or the metal mesh, the first and the second titanium metal sheet and the metal mesh are positioned in the atmosphere furnace; and the atmosphere furnace being heated to 400° C.˜700° C. for 30˜90 minutes.

11. The method of manufacturing a heat dissipation device as claimed in claim 1, wherein the plurality of raised sections on one side of the first titanium metal sheet is formed by etching, stamping or machining; and wherein, in the case of forming the raised sections by stamping, the surface of the first titanium metal sheet is recessed or embossed.
